(19) United States
(12) Patent Application Publication
(10) Pub. No.: US 2026/0241808 A1
(43) Pub. Date: Aug. 20, 2026

(54) FUEL CELL VEHICLE

(71) Applicant: SUBARU CORPORATION, Tokyo (JP)

(72) Inventor: Aiko HIRAWAKI, Tokyo (JP)

(21) Appl. No.: 18/881,791

(22) PCT Filed: May 15, 2023
(86) PCT No.: PCT/JP2023/018061

§ 371 Date: Jan. 7, 2025

(51) Int. Cl. B60L 50/71; B60K 1/02; H01M 8/04082; H01M 8/10

(52) U.S. Cl. CPC B60L 50/71; B60K 1/02; H01M 8/04201; H01M 2008/1095; H01M 2250/20

(57) ABSTRACT

A fuel cell vehicle includes: a container support mechanism that supports a hydrogen container to cause a longitudinal direction of the hydrogen container and a vehicle length direction of a vehicle to be parallel to a middle part, under a floor of the vehicle, in a vehicle width direction of the vehicle; a motor drive device disposed a front side a rear side in the vehicle length direction of the container support mechanism; and a drive device support mechanism that supports a side, of the motor drive device, that is opposed to the hydrogen container. At least a part of the drive device support mechanism is breakable. An end of the hydrogen container is configured to be moved when a collision load of the vehicle is received, and interfere with the drive device support mechanism to cause the hydrogen container to slide to under the motor drive device.

### TECHNICAL FIELD

The disclosure relates to a fuel cell vehicle mounted with a fuel cell.

### BACKGROUND ART

In recent years, a fuel cell vehicle mounted with a fuel cell in which an environmental burden is relatively small has been developed. The fuel cell vehicle obtains a necessary driving force by supplying an electric energy generated by the fuel cell to an electric motor. Accordingly, the fuel cell vehicle includes a motor to be driven by electric power of the fuel cell, and a motor drive unit that contains a drive mechanism designed to transmit the driving force of the motor to wheels.

As with other vehicles, countermeasures are necessary when a collision load is applied to the fuel cell vehicle from the outside. For example, Patent Literature 1 proposes a technique that makes it possible to minimize a damage to the motor drive unit upon a rear collision.

### CITATION LIST

### Patent Literature

Patent Literature 1: Japanese Unexamined Patent Application Publication No. 2022-29621

### SUMMARY OF INVENTION

### Problem to be Solved by the Invention

That is, a technique proposed in Patent Literature 1 described above is effective as a countermeasure upon a collision owing to a movement of a drive mechanism to a space between multiple hydrogen gas containers. On the other hand, it is preferable to dispose the hydrogen containers at a middle part in a vehicle width direction such as inside a floor tunnel due to a space restriction or the like when, for example, a four-wheel drive is to be achieved by the fuel cell vehicle. In such a case, there is room for improvement in the countermeasure upon the collision described above.

The disclosure has been made in view of an example of a problem described above, and an object of the disclosure is to provide a fuel cell vehicle that makes it possible to suppress a damage to a motor drive unit even upon a reception of a collision load from the outside, when a hydrogen container is disposed at a middle part in a vehicle width direction such as inside a floor tunnel.

### Means for Solving the Problem

To solve the problem described above, an aspect of the disclosure provides a fuel cell vehicle including: a container support mechanism that supports a hydrogen container to cause a longitudinal direction of the hydrogen container and a vehicle length direction of a vehicle to be parallel to a middle part, under a floor of the vehicle, in a vehicle width direction of the vehicle; a motor drive device disposed on one or both of a front side and a rear side in the vehicle length direction of the container support mechanism; and a drive device support mechanism that supports a side, of the motor drive device, that is opposed to the hydrogen container. At least a part of the drive device support mechanism is configured to be breakable. An end of the hydrogen container, configured to be moved in response to a reception of a collision load of the vehicle, is configured to interfere with the drive device support mechanism to cause the hydrogen container to slide to a lower side of the motor drive device.

### Effects of the Invention

According to the disclosure, it is possible to suppress a damage of a motor drive unit even when a fuel cell vehicle receives a collision load from the outside.

### BRIEF DESCRIPTION OF DRAWINGS

FIG. 1 is a diagram schematically illustrating, from a side surface side, a configuration of a fuel cell vehicle according to an embodiment.

FIG. 2 is a diagram schematically illustrating, from a bottom surface side, a configuration of the fuel cell vehicle according to an embodiment.

FIG. 3 is a diagram schematically illustrating a configuration of a container support mechanism and a drive device support mechanism in the fuel cell vehicle according to an embodiment.

FIG. 4 is a schematic diagram illustrating an arrangement of a motor drive device provided in a motor case, a motor configuring the motor drive device, and a final gear in the fuel cell vehicle according to an embodiment.

FIG. 5 is a diagram schematically illustrating, from a front of the vehicle, a configuration of the drive device support mechanism mounted on the fuel cell vehicle according to an embodiment.

FIG. 6 is a diagram schematically illustrating, from a side of the vehicle, a configuration of the drive device support mechanism mounted on the fuel cell vehicle according to an embodiment.

FIG. 7 is a diagram schematically illustrating, from a rear of the vehicle, a configuration of the drive device support mechanism mounted on the fuel cell vehicle according to an embodiment.

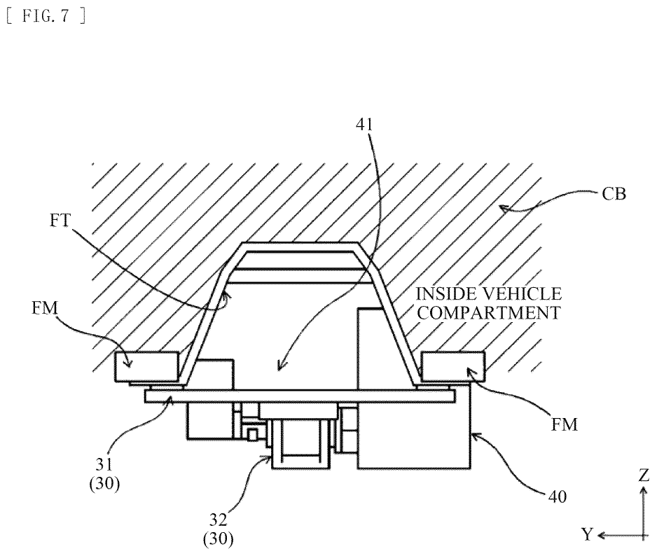

FIG. 8 is a schematic diagram illustrating examples of a structure of a support member configuring a first mount bracket mounted on the fuel cell vehicle according to an embodiment.

FIG. 9 is a schematic diagram illustrating a state transition of a hydrogen container and the drive device support mechanism when the fuel cell vehicle has received a collision load.

### MODES FOR CARRYING OUT THE INVENTION

A preferred embodiment of the disclosure will now be described. It is to be noted that, in this specification and the drawings, components that have substantially the same function and configuration are denoted with the same reference numerals, thereby refraining from repeatedly describing these components. Further, for any configuration other than those described in detail below, an element technology and a configuration related to a known fuel cell system and a known fuel cell vehicle including the above-described Patent Literature may be supplemented as necessary.

### <Fuel Cell Vehicle 100>

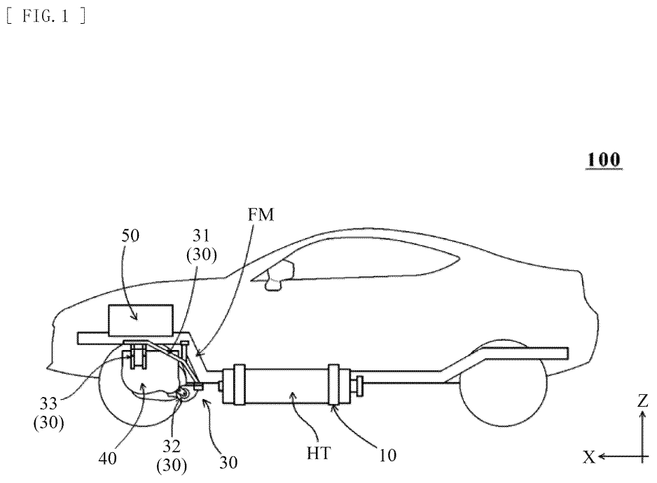

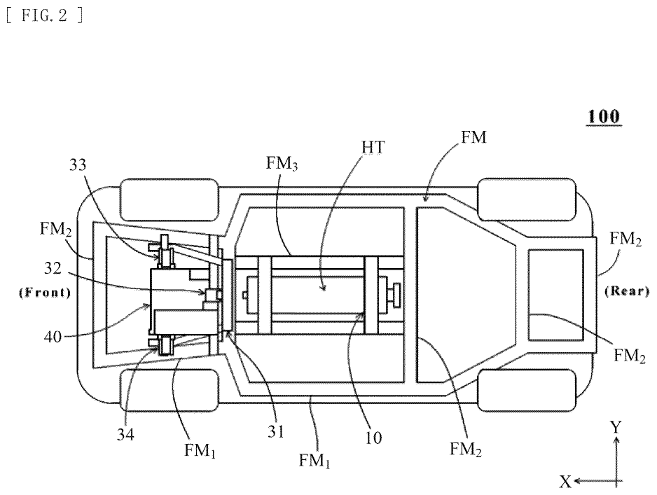

FIGS. 1 and 2 are each a schematic diagram illustrating a configuration of a fuel cell vehicle 100 including a fuel cell stack 50 according to the present embodiment. The fuel cell vehicle 100 has devices including a container support mechanism 10, a motor drive device 20, a drive device support mechanism 30. In addition to the above-described configuration, the fuel cell vehicle 100 according to the present embodiment may include various known in-vehicle devices such as various controllers (ECUs) and an inverter.

The fuel cell stack 50 of the present embodiment includes known fuel-cell cells that are stacked, and configured to supply electric power necessary for driving of an electric motor 21 to be described later. Examples of the fuel-cell cell include a known PEFC (Polymer Electrolyte Fuel Cell). As illustrated in FIG. 1, such a fuel cell stack 50 is fixed on a later-described drive device support mechanism 30 (a support frame 31) via a known fixer such as bolting.

The container support mechanism 10 has a function of supporting a hydrogen container HT to cause a longitudinal direction of the hydrogen container HT and a vehicle length direction (an X direction) to be parallel to a middle part, under a floor of a vehicle, in a vehicle width direction (a Y direction). More specifically, as can be appreciated from FIGS. 1 and 2, the container support mechanism 10 has a known fastening member 11 configured by, for example, a fastening band, and the hydrogen container HT may be fixed to a body frame FM through the fastening member 11.

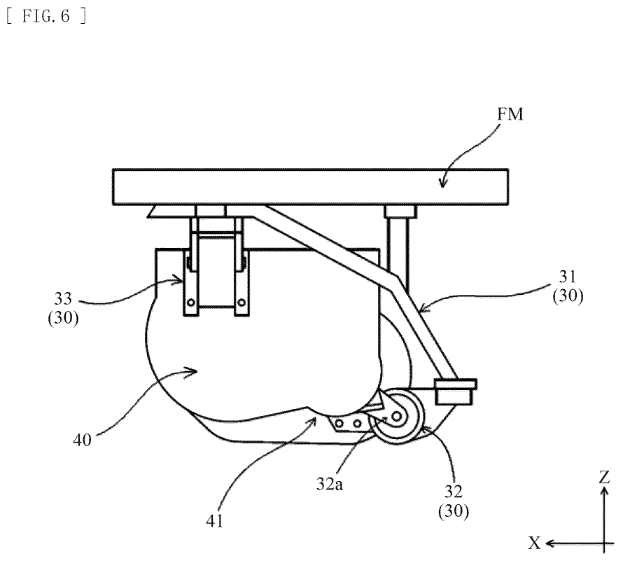

The body frame FM is a member configuring an inner frame that serves as a skeleton of the vehicle, and has, for example, members including a known side member FM₁ and a known cross member FM₂. The hydrogen container HT may be fixed, through the fastening member 11, to a floor member FM₃ disposed in the vicinity of a floor tunnel FT (see FIG. 6) at a lower part of a cabin CB of the body frame.

Here, as illustrated in FIGS. 1 and 2, a form in which the hydrogen container HT is so supported in the vehicle that the longitudinal direction of the hydrogen container HT is parallel to the vehicle length direction is referred to as a “tandem support”. In addition, the wording “the middle part in the vehicle width direction (the Y direction) under the floor of the vehicle” refers to a region positioned between a driver's seat and a passenger's seat in the vehicle, and includes, for example, a region in which a floor tunnel FT in the vehicle is disposed.

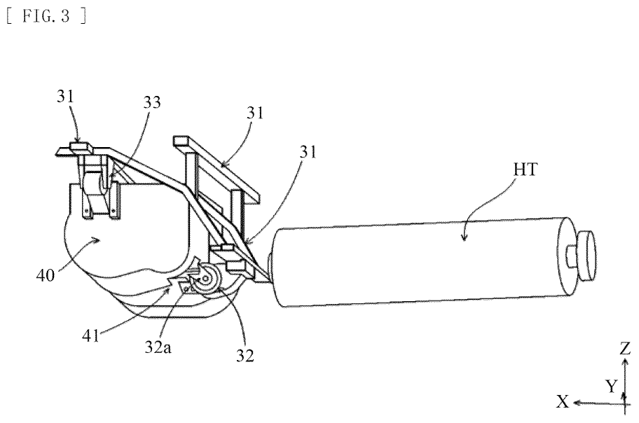

As illustrated in FIG. 3, the hydrogen container HT may be so supported in tandem to the body frame FM that, for example, an end side on which a hydrogen outlet is provided faces the front of the vehicle.

The motor drive device 20 may be disposed on one or both of a front side and a rear side in the vehicle length direction with respect to the container support mechanism 10. As illustrated in the drawings including FIGS. 2 and 3, the motor drive device 20 of the present embodiment is disposed on a front side in the vehicle length direction of the fuel cell vehicle 100 (for example, inside a space corresponding to an engine room on a front side).

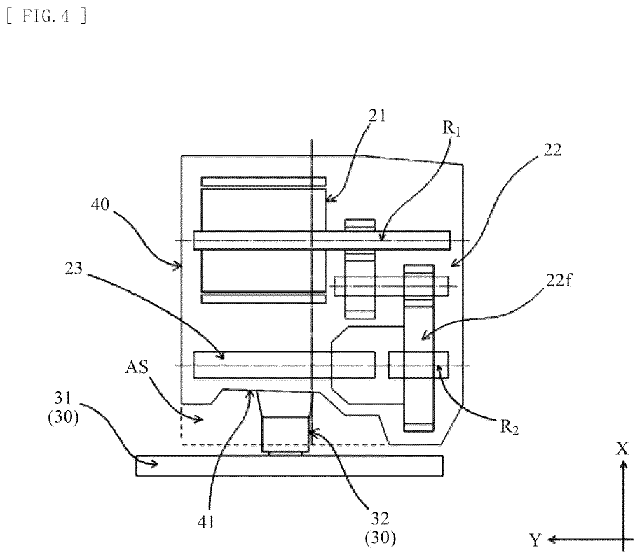

Alternatively, the motor drive device 20 may be provided through the later-described drive device support mechanism 30 on a rear side (for example, a region corresponding to a luggage compartment on a rear side) in the vehicle length direction with respect to the container support mechanism 10. As illustrated in FIG. 4, the motor drive device 20 of the present embodiment is contained in a motor case 40. As illustrated in the drawings including FIG. 2, the motor case 40 containing the motor drive mechanism 20 is supported by the drive device support mechanism 30 fixed to the body frame FM.

As can be appreciated from the drawings including FIG. 2, the drive device support mechanism 30 is fixed, through a known fixing method such as welding or bolting, to the side members FM₁ respectively positioned on both sides, in the vehicle width direction, of the body frame FM. As described above, the drive device support mechanism 30 has a function of supporting the fuel cell stack 50 and supporting motor case 40 (the motor drive device 20) through later-described multiple mount brackets.

More specifically, the drive device support mechanism 30 of the present embodiment includes: a support frame 31 fixed to the body frame FM configuring a skeleton of the vehicle; and a first mount bracket 32 to a third mount bracket 34 that are attached to the support frame 31 and each support the motor case 40 (i.e., the motor drive device 20).

As will be described later, the first mount bracket 32 supports a rear side of the motor case 40, and the second mount bracket 33 and the third mount bracket 34 support a front side of the motor case 40. Accordingly, in the disclosure, the second mount bracket 33 and the third mount bracket 34 are also referred to as a “front mount bracket” that is attached to the support frame 31 and supports the front of the motor case.

As illustrated in FIGS. 1 to 3, the drive device support mechanism 30 of the present embodiment is disposed side by side at substantially the same height while having a predetermined gap with respect to the hydrogen container HT along the vehicle length direction (the X direction). More specifically, at least the first mount bracket 32 mounted on the support frame 31 of the drive device support mechanism 30 is disposed on an extension line along which the hydrogen container HT moves along the vehicle length direction when the collision load is applied.

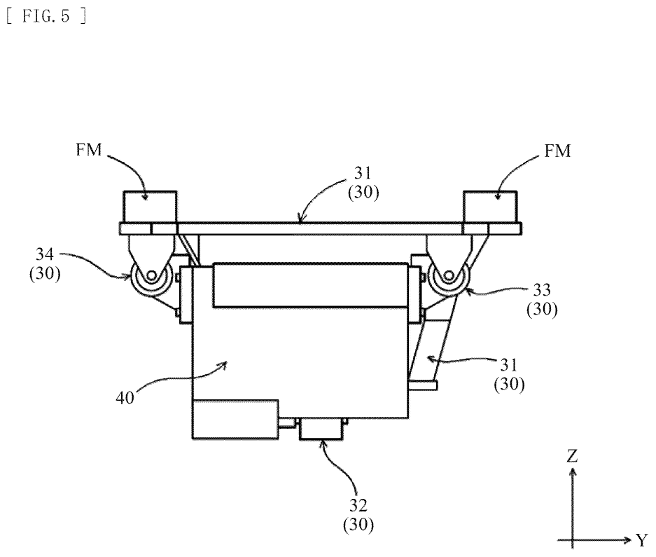

As illustrated in FIGS. 5 and 6, the first mount bracket 32 is mounted below a vehicle rear side of the motor case 40, and supports from a bottom surface side at the rear of the motor case 40. As illustrated in FIG. 3, the first mount bracket 32 supports a rear side of the motor case 40 and a lower side in the vertical (Z) direction of the motor case 40 in the vicinity of the middle in the vehicle width direction.

A specific configuration of the first mount bracket 32 is not particularly limited as long as the motor support member 32a is included and a later-described function is exhibited, and a known mount bracket applicable to the fuel cell vehicle may be applied as a base. In the present embodiment, the rear and the bottom surface side of the motor case 40 is supported by the single first mount bracket 32. Alternatively, the rear and the bottom surface side of the motor case 40 may be supported by the multiple first mount brackets 32.

The second mount bracket 33 is mounted above a left side of the motor case 40, and supports a left side surface of the motor case 40. A specific structure of the second mount bracket 33 is not particularly limited as long as the second mount bracket 33 is fixed to the support frame 31 and configured to support the motor case 40, and a known mount bracket applicable to the fuel cell vehicle may be applied. In the present embodiment, the left side surface and the upper side of the motor case 40 is supported by the single second mount bracket 33. Alternatively, the motor case 40 may be supported by the multiple second mount brackets 33.

The third mount bracket 34 is mounted above a right side of the motor case 40, and supports a right side surface of the motor case 40. A specific structure of the third mount bracket 34 is not particularly limited as long as the third mount bracket 34 is fixed to the support frame 31 and configured to support the motor case 40, and a known mount bracket applicable to the fuel cell vehicle may be applied. In the present embodiment, the right side surface and the upper side of the motor case 40 is supported by the single third mount bracket 34. Alternatively, the motor case 40 may be supported by the multiple third mount brackets 34.

It should be noted that the second mount bracket 33 and the third mount bracket 34 are each fixed to the support frame 31 separately from each other in this example, but may be an integrated structure in which they are continuous along the surroundings of the motor case 40.

In the foregoing present embodiment, the motor case 40 is stably supported at three points through the first mount bracket 32 to the third mount bracket 34. For example, a known metal material such as a steel material may be applied as a material of the support frame 31 that fixes the first to the third mount brackets 32 to 34.

The first mount bracket 32 configuring the drive device support mechanism 30 includes a motor support member 32a having a weakened part WP that is breakable in response to a reception of a collision load equal to or greater than a predetermined value. The wording “the collision load equal to or greater than the predetermined value” may refer to, for example, a load at the time when the hydrogen container HT collides with the first mount bracket 32 upon application of the collision load from the outside, such as a front collision or a rear collision. Such a load may be calculated in advance by experimentation or simulation using a factor such as a weight of the hydrogen container HT, a speed assumed at the time of the collision, or a weight of the vehicle. As described above, the first mount bracket 32 of the present embodiment includes the weakened part WP which is broken by the collision of the end of the hydrogen container HT upon the reception of the collision load.

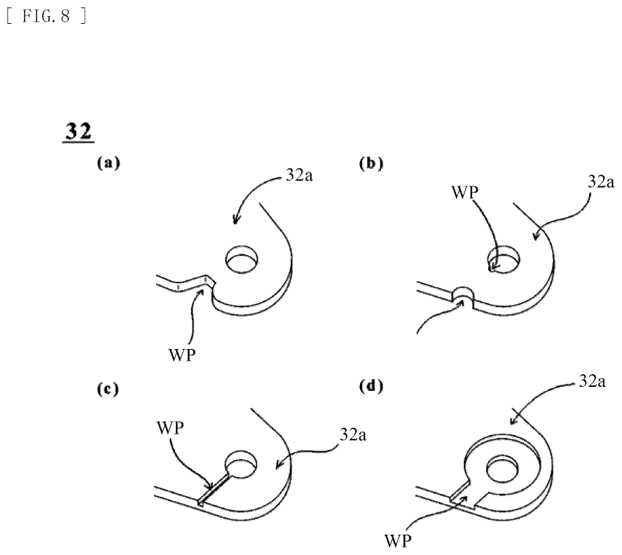

FIG. 8 illustrates examples of a configuration of the motor support member 32a configuring the first mount bracket 32. As can be appreciated from these exemplary structures, the motor support member 32a has the weakened part WP that is configured to be breakable. At least a part of the motor support member 32a is thinned or notched to become frangible and thereby to provide the weakened part WP. Accordingly, when the collision load is applied to the fuel cell vehicle 100 from the outside, the column-supported hydrogen container HT comes into contact with the first mount bracket 32, and the weakened part WP may thus break. A strength (a breaking resistance) of the weakened part WP may be determined based on the collision load calculated by the experimentation or the simulation.

As described above, the first mount bracket 32 of the present embodiment supports a side, of the motor drive device 20, that is opposed to the hydrogen container HT, and at least a part of the first mount bracket 32 is configured to be breakable. Thus, when the collision load is applied to the vehicle from the outside, the support of the motor case 40 (the motor drive device 20) at the rear by the first mount bracket 32 is eliminated, while the support of the motor case 40 by the second mount bracket 33 and the third mount bracket 34 on the sides continue. Accordingly, as will be described later, the end of the hydrogen container HT that is moved in response to the reception of the collision load interferes with the drive device support mechanism 30, allowing the hydrogen container HT to slide to a lower side of the motor drive device 20.

<Arrangement Relationship between Motor Case and First Mount Bracket>

Next, an arrangement relationship between the motor drive device 20 and the drive device support mechanism 30 and between the motor case 40 and the drive device support mechanism 30 of the present embodiment will be described with reference to FIG. 4.

As illustrated in FIG. 4, the motor case 40 of the present embodiment contains the motor drive device 20. The motor drive device 20 includes: the known electric motor 21 that applies a driving force to the fuel cell vehicle 100; a drive gear 22 that transmits the driving force of the electric motor 21; and an output shaft 23 coupled to a termination gear 22f of the drive gear 22.

The motor case 40 has, on a side opposed to the hydrogen container HT, a recess 41 recessed toward the output shaft 23 of the motor drive device 20. As illustrated in FIG. 4, a part of the drive mechanism support mechanism 30 (the first mount bracket 32 that supports the rear side of the motor case 40 in the vehicle length direction) is disposed inside an accommodation space AS formed by the recess 41 of the motor case 40. Accordingly, normally, a member such as a reinforcing rib is necessary separately when the recess 41 is formed in the motor case; however, the first mount bracket 32 disposed inside the recess 41 is able to serve both a function of supporting the motor case 40 and a function of reinforcing the motor case 40.

In addition, in the present embodiment, a rotation shaft R1 of the electric motor 21 and a rotation shaft R2 of the output shaft 23 are disposed side by side, and the termination gear 22f and the output shaft 23 are provided between the electric motor 21 and the hydrogen container HT. This makes it possible to bring the hydrogen container HT and components including the motor drive device 20 and the fuel cell stack 50 close to each other and to achieve a compact structure with an improved space efficiency.

<Transition of State Upon Application of Collision Load from Outside>

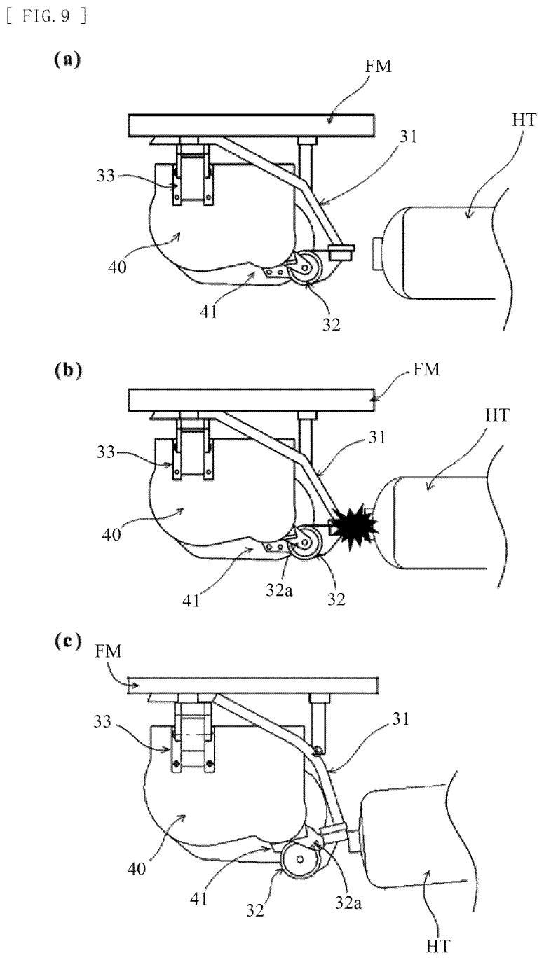

Next, a transition of state of each configuration when the fuel cell vehicle 100 according to the present embodiment receives the collision load from the outside will be described with reference to FIG. 9.
(a) of FIG. 9 illustrates a state in which the fuel cell vehicle 100 is traveling. At this time, the hydrogen gas is supplied from the hydrogen container HT to the fuel cell stack 50 to thereby generate electric power. The electric power generated in the fuel cell stack 50 may be charged in, for example, a known vehicle-mounted storage battery and at least a part of the electric power may be supplied to the electric motor 21 through a device such as a known inverter.
(b) of FIG. 9 illustrates a state in which the fuel cell vehicle 100 has received the collision load from the outside due to any factor such as the front collision. At this time, for example, the column-supported hydrogen container HT may be moved to the front by being released from the restraint derived from the container support mechanism 10. Thus, as illustrated, the end of the hydrogen container HT that has moved to the front may come into contact with the drive device support mechanism 30 (e.g., the support frame 31). The first mount bracket 32 supported by the support frame 31 is provided on the rear side of the driving device support mechanism 30, allowing the weakened part WP of the motor support member 32a to be broken due to an influence of the contact by the hydrogen container HT.

Then, as illustrated in (c) of FIG. 9, the end of the hydrogen container HT that moves in response to the reception of the collision load interferes with the drive device supporting device 30, and the weakened part WP is broken. Thus, the first mount bracket 32 itself is also moved by being pushed out from an initial position to the front side of the vehicle by the hydrogen container HT. In addition, the support on the rear side of the motor case 40 (the motor drive device 20) by the first mount bracket 32 is released, following which the hydrogen container HT is slidable to the lower side of the motor case 40 (the motor drive device 20).

In the present embodiment, the hydrogen container HT that has moved upon the collision breaks the support by the support frame 31 of the first mount bracket 32, allowing the rear side of the motor drive device 20 to be lifted vertically upward while the hydrogen container HT slides to the lower side of the motor drive device 20.

In addition, as can be appreciated from the drawings including FIG. 4, the output shaft 23 and the termination gear 22f are interposed between the electric motor 21 of the motor drive device 20 and the first mount bracket 32. Thus, even if the hydrogen container HT has relatively moved forward in response to the reception of the collision load, the collision between the electric motor 21 and the hydrogen container HT is suppressed, preventing a large amount of damage from being applied to the fuel cell vehicle 100.

Further, as illustrated in FIG. 4, the recess 41 is formed on the rear side (a minus X direction in FIG. 4) of the output shaft 23 of the motor drive device 20 to have the accommodation space AS, making it possible to achieve a space saving by accommodating at least a part of the drive device support mechanism 30 (for example, a member such as the first mount bracket 32) inside the accommodation space AS. Although the first mount bracket 32 is disposed in the accommodation space AS in the present embodiment, there may be an embodiment in which a part of the support frame 31 is further accommodated.

The preferred embodiment(s) of the disclosure has/have been described above in detail with reference to the accompanying drawings, whilst a technique of the disclosure is not limited to the above examples. It will be apparent to those skilled in the art that various modifications and variations can be made within the scope of the technical idea recited in the claims, and those modifications and variations of the disclosure will be obviously understood as falling within the scope of the disclosure.

### REFERENCE SIGNS LIST

10: Container support mechanism
20: Motor drive device
30: Drive device support mechanism
40: Motor case
50: Fuel cell stack
FM: Body frame
FT: Floor tunnel
CB: Cabin
100: Fuel cell vehicle

1. A fuel cell vehicle comprising:
a container support mechanism that supports a hydrogen container to cause a longitudinal direction of the hydrogen container and a vehicle length direction of a vehicle to be parallel to a middle part, under a floor of the vehicle, in a vehicle width direction of the vehicle;
a motor drive device disposed on one or both of a front side and a rear side in the vehicle length direction of the container support mechanism; and
a drive device support mechanism that supports a side, of the motor drive device, that is opposed to the hydrogen container, and at least a part of the drive device support mechanism being configured to be breakable, wherein
an end of the hydrogen container, configured to be moved in response to a reception of a collision load of the vehicle, is configured to interfere with the drive device support mechanism to cause the hydrogen container to slide to a lower side of the motor drive device.

2. The fuel cell vehicle according to claim 1, wherein the drive device support mechanism includes:
a support frame fixed to a body frame;
a first mount bracket that is attached to the support frame, and supports a rear of the motor drive device from a lower side in a vertical direction of the motor case; and
a front mount bracket that is attached to the support frame, and supports a front of the motor drive device.

3. The fuel cell vehicle according to claim 2, further comprising a motor case that contains the motor drive device, wherein
the motor case comprises, on a side opposed to the hydrogen container, a recess recessed toward an output shaft of the motor drive device, and
at least a part of the first mount bracket that supports the motor drive device is disposed inside the recess.

4. The fuel cell vehicle according to claim 3, wherein the first mount bracket comprises a weakened part in which at least a part of the first mount bracket is thinned or notched.

5. The fuel cell vehicle according to claim 4, wherein the hydrogen container, moved in response to the reception of the collision load, is configured to break the support by the support frame of the first mount bracket, and to allow a rear side of the motor drive device to be lifted vertically upward while the hydrogen container slides to the lower side of the motor drive device.
